(19) United States
(12) Patent Application Publication
(10) Pub. No.: US 2024/0021924 A1
(43) Pub. Date: Jan. 18, 2024

(54) SOLID STATE BATTERY PACKAGE

(71) Applicant: Murata Manufacturing Co., Ltd., Nagaokakyo-shi (JP)

(72) Inventor: Yusuke IKUTA, Nagaokakyo-shi (JP)

(21) Appl. No.: 18/348,183

(22) Filed: Jul. 6, 2023

(30) Foreign Application Priority Data
Jul. 11, 2022 (JP) 2022-111228

(51) Int. Cl. H01M 50/103; H01M 10/0585; H01M 50/124; H01M 50/117; H01M 50/128

(52) U.S. Cl. CPC H01M 50/103; H01M 10/0585; H01M 50/124; H01M 50/117; H01M 50/128

(57) ABSTRACT

A solid-state battery package that includes a substrate; a solid-state battery on the substrate; and an exterior part that covers the solid-state battery, where the exterior part includes a plurality of corners, and at least a top surface-side corner of the plurality of corners has an outward curved surface that is curved outward relative to the solid-state battery.

### CROSS REFERENCE TO RELATED APPLICATIONS

The present application claims priority to Japanese Patent Application No. 2022-111228, filed Jul. 11, 2022, the entire contents of which are incorporated herein by reference.

### BACKGROUND OF THE INVENTION

### Field of the Invention

The present disclosure relates to a solid-state battery package. More specifically, the present disclosure relates to a solid-state battery packaged so as to be adapted for mounting on a substrate.

### Description of the Related Art

Conventionally, a secondary battery that can be repeatedly charged and discharged has been used for various applications. For example, secondary batteries are used as power sources of electronic devices such as smart phones and notebook computers.

In secondary batteries, a liquid electrolyte is generally used as a medium for ion transfer contributing to charging and discharging. More particularly, a so-called electrolytic solution is used for the secondary battery. However, in such a secondary battery, safety is generally required in terms of preventing leakage of the electrolytic solution. Since an organic solvent or the like used for the electrolytic solution is a flammable substance, safety is required also in that respect.

Thus, solid-state batteries with solid electrolytes used instead of electrolytic solutions have been studied.

### SUMMARY OF THE INVENTION

The solid-state batteries are covered with a covering member for preventing ingress of water vapor, thereby forming solid-state battery packages (Japanese Patent Application Laid-Open Nos. 2015-220107 and 2010-503957). Such a solid-state battery packages can be exposed to mechanical stress from the outside in processes of mounting by customers or handling processes in the market. In this regard, as in Japanese Patent Application Laid-Open Nos. 2015-220107 and 2010-503957, when the solid-state battery or the covering member includes, at a corner or the like thereof, a bent part at approximately 90 degrees, which is exposed to the outside, there is a possibility that mechanical stress such as physical contact from the outside will be concentrated on the bent part, thereby causing defects such as a crack. Such a defect of the solid-state battery or the covering member may possibly decrease the function of water vapor ingress prevention of the solid-state battery package as a whole.

The present disclosure has been made in view of such problems. More specifically, a main object of the present disclosure is to provide a solid-state battery package with further improved resistance to mechanical stress from the outside.

For achieving the object mentioned above, an embodiment of the present invention provides a solid-state battery package including a substrate; a solid-state battery on the substrate; and an exterior part that covers the solid-state battery, where the exterior part includes a plurality of corners, and at least a top surface-side corner of the plurality of corners has an outward curved surface that is curved outward relative to the solid-state battery.

The solid-state battery package according to an embodiment of the present invention has further improved resistance to mechanical stress from the outside.

### BRIEF DESCRIPTION OF THE DRAWINGS

FIG. 1 is a sectional view schematically illustrating the internal configuration of a solid-state battery according to an embodiment of the present invention;

FIG. 2 is a perspective view schematically illustrating the solid-state battery package according to an embodiment of the present invention;

FIG. 3 is a sectional view schematically illustrating the configuration of a solid-state battery package according to an embodiment of the present invention;

FIG. 4 is an enlarged sectional view schematically illustrating a part A of the solid-state battery package shown in FIG. 3;

FIG. 5 is an enlarged sectional view schematically illustrating a part A of a solid-state battery package according to another embodiment of the present invention;

FIG. 6 is an enlarged sectional view schematically illustrating a part A of a solid-state battery package according to another embodiment of the present invention;

FIG. 7 is a sectional view schematically illustrating the configuration of a solid-state battery package according to an embodiment of the present invention;

FIG. 8 is an enlarged sectional view schematically illustrating a part B of the solid-state battery package shown in FIG. 7;

FIG. 9 is a sectional view schematically illustrating the configuration of a solid-state battery package according to another embodiment of the present invention;

FIG. 10 is a sectional view schematically illustrating the configuration of a solid-state battery package according to another embodiment of the present invention;

FIG. 11 is a sectional view schematically illustrating the configuration of a solid-state battery package according to another embodiment of the present invention;

FIG. 12A is a step sectional view schematically illustrating a process for manufacturing a solid-state battery package according to an embodiment of the present invention;

FIG. 12B is a step sectional view schematically illustrating a process for manufacturing a solid-state battery package according to an embodiment of the present invention;

FIG. 12C is a step sectional view schematically illustrating a process for manufacturing a solid-state battery package according to an embodiment of the present invention;

FIG. 12D is a step sectional view schematically illustrating a process for manufacturing a solid-state battery package according to an embodiment of the present invention; and

FIG. 12E is a step sectional view schematically illustrating a process for manufacturing a solid-state battery package according to an embodiment of the present invention.

### DETAILED DESCRIPTION OF THE INVENTION

Hereinafter, a solid-state battery package according to the present invention will be described in detail. Although description will be made with reference to the drawings as necessary, the shown contents are only schematically and exemplarily illustrated for the understanding of the present invention, and the appearance, the dimensional ratio, and the like may be different from the actual ones.

The term “solid-state battery package” as used herein refers, in a broad sense, to a solid-state battery device configured to protect the solid-state battery from the external environments, and in a narrow sense, to a solid-state battery device that includes a mountable substrate and protects the solid-state battery from the external environment.

The term “sectional view” as used herein is based on a form (briefly, a form in the case of being cut along a plane parallel to the layer thickness direction) viewed from a direction substantially perpendicular to the stacking direction in the stacked structure of the solid-state battery. In addition, the term “plan view” or “plan view shape” used in the present specification is based on a sketch drawing when an object is viewed from an upper side or a lower side along the layer thickness direction (that is, the stacking direction mentioned above).

The “vertical direction” and “horizontal direction” used directly or indirectly in the present specification respectively correspond to the vertical direction and horizontal direction in the drawings. Unless otherwise specified, the same symbols or signs shall denote the same members or sites or the same meanings. In a preferred aspect, it can be understood that a downward direction in a vertical direction (that is, a direction in which gravity acts) corresponds to a “downward direction”/a “bottom surface side”, and an opposite direction thereof corresponds to an “upward direction”/a “top surface side”.

In addition, in the present specification, the phrase of “on” a substrate, a film, a layer, or the like includes not only a case in contact with the upper surface of the substrate, film, or layer, but also a case out of contact with the upper surface of the substrate, film, or layer. More particularly, the phrase of “on” a substrate, a film, or a layer includes a case where a new film or layer is formed above the substrate, film, or layer, and/or a case where another film or layer is interposed over the substrate, film, or layer. In addition, the term “on” does not necessarily mean the upper side in the vertical direction. The term “on” merely indicates a relative positional relationship of a substrate, a film, a layer, or the like.

[Basic Configuration of Secondary Battery]

The term “secondary battery” as used in the present specification refers to a battery that can be repeatedly charged and discharged. Accordingly, the secondary battery according to the present invention is not excessively limited by its name, and for example, an “electric storage device and the like can also be included in the subject of the present invention.

The term “solid-state battery” used in the present invention refers to, in a broad sense, a battery whose constituent elements are composed of solid and refers to, in a narrow sense, all solid-state battery whose constituent elements (particularly preferably all constituent elements) are composed of solid. In a preferred mode, the solid-state battery in the present invention is a stacked solid-state battery configured such that layers constituting a battery constituent unit are stacked on each other, and such layers are preferably composed of fired bodies. The “solid-state battery” encompasses not only a so-called “secondary battery” that can be repeatedly charged and discharged but also a “primary battery” that can only be discharged. According to a preferred aspect of the present invention, the “solid-state battery” is a secondary battery. The “secondary battery” is not to be considered excessively restricted by its name, which can encompass, for example, a power storage device and the like. Further, in the present invention, the solid-state battery included in the package can also be referred to as a “solid-state battery element”.

Hereinafter, the basic configuration of the solid-state battery according to the present invention will be first described. The configuration of the solid-state battery described here is merely an example for understanding the invention, and not considered limiting the invention.

[Basic Configuration of Solid-state Battery]

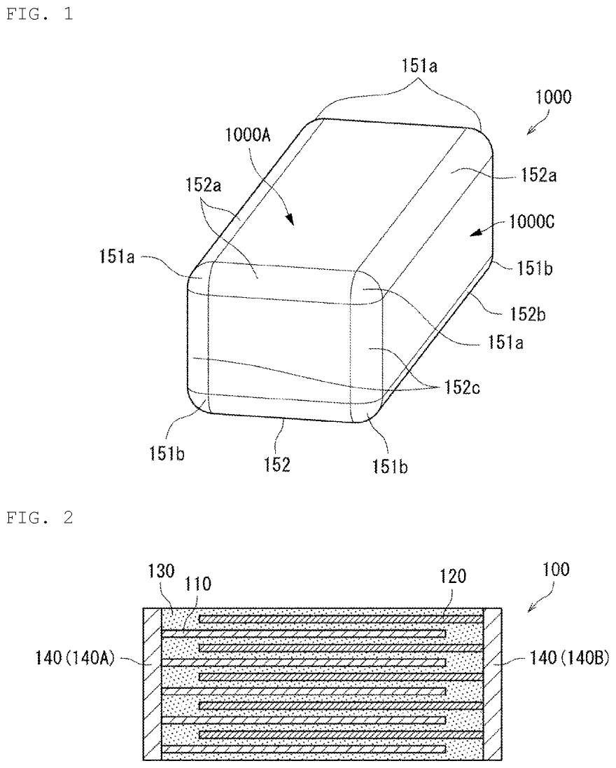

The solid-state battery includes at least electrode layers of a positive electrode and a negative electrode, and a solid electrolyte. Specifically, as illustrated in FIG. 1, a solid-state battery 100 includes a solid-state battery stack including a battery constituting unit composed of a positive electrode layer 110, a negative electrode layer 120, and a solid electrolyte 130 at least interposed between the electrode layers.

For the solid-state battery, each layer constituting the solid-state battery may be formed by firing, and the positive electrode layer, the negative electrode layer, the solid electrolyte, and the like may form fired layers. Preferably, the positive electrode layer, the negative electrode layer, and the solid electrolyte are each fired integrally with each other, and thus, the solid-state battery stack preferably forms an integrally fired body.

The positive electrode layer is an electrode layer containing at least a positive electrode active material. The positive electrode layer may further contain a solid electrolyte. In a preferred aspect, the positive electrode layer is composed of a fired body including at least positive electrode active material particles and solid electrolyte particles. In contrast, the negative electrode layer is an electrode layer containing at least a negative electrode active material. The negative electrode layer may further contain a solid electrolyte. In a preferred embodiment, the negative electrode layer is composed of a sintered body including at least negative electrode active material particles and solid electrolyte particles.

The positive electrode active material and the negative electrode active material are substances involved in the transfer of electrons in the solid-state battery. Ions move (conduct) between the positive electrode layer and the negative electrode layer through the solid electrolyte to transfer electrons, thereby charging and discharging the battery. Each electrode layer of the positive electrode layer and the negative electrode layer is preferably a layer capable of occluding and releasing lithium ions or sodium ions, in particular. More particularly, the solid-state battery is preferably an all-solid-state secondary battery in which lithium ions or sodium ions move between the positive electrode layer and the negative electrode layer through the solid electrolyte interposed, thereby charging and discharging the battery.

(Positive Electrode Active Material)

Examples of the positive electrode active material included in the positive electrode layer include at least one selected from the group consisting of lithium-containing phosphate compounds that have a NASICON-type structure, lithium-containing phosphate compounds that have an olivine-type structure, lithium-containing layered oxides, lithium-containing oxides that have a spinel-type structure, and the like. Examples of the lithium-containing phosphate compounds that have a NASICON-type structure include Li₃V₂(PO₄)₃. Examples of the lithium-containing phosphate compounds that have an olivine-type structure include Li₃Fe₂(PO₄)₃, LiFePO₄, and/or LiMnPO₄. Examples of the lithium-containing layered oxides include LiCoO₂ and/or LiCo_{1/3}Ni_{1/3}Mn_{1/3}O₂. Examples of the lithium-containing oxides that have a spinel-type structure include LiMn₂O₄ and/or LiNi_{0.5}Mn_{1.5}O₄. The types of the lithium compounds are not particularly limited, and may be regarded as, for example, a lithium-transition metal composite oxide and a lithium-transition metal phosphate compound. The lithium-transition metal composite oxide is a generic term for oxides containing lithium and one or two or more transition metal elements as constituent elements, and the lithium transition metal phosphate compound is a generic term for phosphate compounds containing lithium and one or two or more transition metal elements as constituent elements. The types of transition metal elements are not particularly limited and are, for example, cobalt (Co), nickel (Ni), manganese (Mn), iron (Fe), and the like.

In addition, examples of positive electrode active materials capable of occluding and releasing sodium ions include at least one selected from the group consisting of sodium-containing phosphate compounds that have a NASICON-type structure, sodium-containing phosphate compounds that have an olivine-type structure, sodium-containing layered oxides, sodium-containing oxides that have a spinel-type structure, and the like. For example, in the case of the sodium-containing phosphate compounds, examples thereof include at least one selected from the group consisting of Na₃V₂(PO₄)₃, NaCoFe₂(PO₄)₃, Na₂Ni₂F(PO₄)₃, Na₃Fe₂(PO₄)₃, Na₂FeP₂O₇, Na₄Fe₃(PO₄)₂(P₂O₇), and NaFeO₂ as a sodium-containing layered oxide.

In addition, the positive electrode active material may be, for example, an oxide, a disulfide, a chalcogenide, a conductive polymer, or the like. The oxide may be, for example, a titanium oxide, a vanadium oxide, a manganese dioxide, or the like. The disulfide is, for example, a titanium disulfide, a molybdenum sulfide, or the like. The chalcogenide may be, for example, a niobium selenide or the like. The conductive polymer may be, for example, a disulfide, a polypyrrole, a polyaniline, a polythiophene, a poly-para-styrene, a polyacetylene, a polyacene, or the like.

(Negative Electrode Active Material)

Examples of the negative electrode active material included in the negative electrode layer include at least one selected from the group consisting of oxides containing at least one element selected from the group consisting of titanium (Ti), silicon (Si), tin (Sn), chromium (Cr), iron (Fe), niobium (Nb), and molybdenum (Mo), carbon materials such as graphite, graphite-lithium compounds, lithium alloys, lithium-containing phosphate compounds that have a NASICON-type structure, lithium-containing phosphate compounds that have an olivine-type structure, and lithium-containing oxides that have a spinel-type structure. Examples of the lithium alloys include Li—Al. Examples of the lithium-containing phosphate compounds that have a NASICON-type structure include Li₃V₂ (PO₄)₃ and/or LiTi₂ (PO₄)₃. Examples of the lithium-containing phosphate compounds that have an olivine-type structure include Li₃Fe₂(PO₄)₃ and/or LiCuPO₄. Examples of the lithium-containing oxides that have a spinel-type structure include Li₄Ti₅O₁₂.

In addition, examples of negative electrode active materials capable of occluding and releasing sodium ions include at least one selected from the group consisting of sodium-containing phosphate compounds that have a NASICON-type structure, sodium-containing phosphate compounds that have an olivine-type structure, and sodium-containing oxides that have a spinel-type structure.

Further, in the solid-state battery, the positive electrode layer and the negative electrode layer are made of the same material.

The positive electrode layer and/or the negative electrode layer may include a conductive material. Examples of the conductive material included in the positive electrode layer and the negative electrode layer include at least one of metal materials such as silver, palladium, gold, platinum, aluminum, copper, and nickel, and carbon.

Further, the positive electrode layer and/or the negative electrode layer may include a sintering aid. Examples of the sintering aid include at least one selected from the group consisting of a lithium oxide, a sodium oxide, a potassium oxide, a boron oxide, a silicon oxide, a bismuth oxide, and a phosphorus oxide.

The thicknesses of the positive electrode layer and negative electrode layer are not particularly limited, but may be, independently of each other, for example, 2 μm to 50 μm, particularly 5 μm to 30 μm.

(Positive Electrode Current Collecting Layer/Negative Electrode Current Collecting Layer)

Although not an essential element for the electrode layer, the positive electrode layer and the negative electrode layer may respectively include a positive electrode current collecting layer and a negative electrode current collecting layer. The positive electrode current collecting layer and the negative electrode current collecting layer may each have the form of a foil. The positive electrode current collecting layer and the negative electrode current collecting layer may each have, however, the form of a fired body, if more importance is placed on viewpoints such as improving the electron conductivity, reducing the manufacturing cost of the solid-state battery, and/or reducing the internal resistance of the solid-state battery by integral firing. As the positive electrode current collector constituting the positive electrode current collecting layer and the negative electrode current collector constituting the negative electrode current collector, it is preferable to use a material with a high conductivity, and for example, silver, palladium, gold, platinum, aluminum, copper, and/or nickel may be used. The positive electrode current collector and the negative electrode current collector may each have an electrical connection for being electrically connected to the outside, and may be configured to be electrically connectable to an end-face electrode. It is to be noted that when the positive electrode current collecting layer and the negative electrode collecting layer have the form of a fired body, the layers may be composed of a sintered body including a conductive material and a sintering aid. The conductive material included in the positive electrode current collecting layer and the negative electrode current collecting layer may be selected from, for example, the same materials as the conductive materials that can be included in the positive electrode layer and the negative electrode layer. The sintering aid included in the positive electrode current collecting layer and the negative electrode current collecting layer may be selected from, for example, the same materials as the sintering aids that can be included in the positive electrode layer/the negative electrode layer As described above, in the solid-state battery, the positive electrode current collecting layer and the negative electrode current collecting layer are not essential, and a solid-state battery provided without such a positive electrode current collecting layer or a negative electrode current collecting layer is also conceivable. More particularly, the solid-state battery included in the package included the present invention may be a solid-state battery without any current collecting layer.

(Solid Electrolyte)

The solid electrolyte is a material capable of conducting lithium ions or sodium ions. In particular, the solid electrolyte that forms the battery constituent unit in the solid-state battery may form a layer capable of conducting lithium ions between the positive electrode layer and the negative electrode layer. It is to be noted that the solid electrolyte has only to be provided at least between the positive electrode layer and the negative electrode layer. More particularly, the solid electrolyte may be present around the positive electrode layer and/or the negative electrode layer so as to protrude from between the positive electrode layer and the negative electrode layer. Specific examples of the solid electrolyte include any one, or two or more of a crystalline solid electrolyte, a glass-based solid electrolyte, and a glass ceramic-based solid electrolyte.

Examples of the crystalline solid electrolyte include oxide-based crystal materials and sulfide-based crystal materials. Examples of the oxide-based crystal materials include lithium-containing phosphate compounds that have a NASICON structure, oxides that have a perovskite structure, oxides that have a garnet-type or garnet-type similar structure, and oxide glass ceramic-based lithium ion conductors.

Examples of the lithium-containing phosphate compound that has a NASICON structure include LiₓM_{y}(PO₄)₃ (1≤x≤2, 1≤y≤2, M is at least one selected from the group consisting of titanium (Ti), germanium (Ge), aluminum (Al), gallium (Ga), and zirconium (Zr)). Examples of the lithium-containing phosphate compounds that have a NASICON structure include Li_{1.2}Al_{0.2}Ti_{1.8}(PO₄)₃. Examples of the oxides that have a perovskite structure include La_{0.55}Li_{0.35}TiO₃. Examples of the oxides that have a garnet-type or garnet-type similar structure include Li₇La₃Zr₂O₂. In addition, examples of the sulfide-based crystal materials include thio-LISICON, for example, Li_{3.25}Ge_{0.25}P_{0.75}S₄ and Li₁₀GeP₂S₁₂. The crystalline solid electrolyte may contain a polymer material (for example, a polyethylene oxide (PEO)).

Examples of the glass-based solid electrolyte include oxide-based glass materials and sulfide-based glass materials. Examples of the oxide-based glass materials include 50Li₄SiO₄-50Li₃BO₃. In addition, examples of the sulfide-based glass materials include 30Li₂S-26B₂S₃-44LiI, 63Li₂S-36SiS₂-1Li₃PO₄, 57Li₂S-38SiS₂-5Li₄SiO₄, 70Li₂S-30P₂S₅, and 50Li₂S-50GeS₂.

Examples of the glass ceramic-based solid electrolyte include oxide-based glass ceramic materials and sulfide-based glass ceramic materials. As the glass ceramic-based solid electrolyte, for example, a phosphate compound (LATP) containing lithium, aluminum, and titanium as constituent elements, and a phosphate compound (LAGP) containing lithium, aluminum, and germanium as constituent elements can be used. LATP is, for example, Li_{1.07}Al_{0.69}Ti_{1.46} (PO₄)₃. LAGP is, for example, Li_{1.5}Al_{0.5}Ge_{1.5} (PO₄). In addition, examples of the sulfide-based glass ceramic materials include Li₇P₃S₁₁ and Li_{3.25}P_{0.95}S₄.

In addition, examples of the solid electrolyte capable of conducting sodium ions include sodium-containing phosphate compounds that have a NASICON structure, oxides that have a perovskite structure, and oxides that have a garnet-type or garnet-type similar structure. Examples of the sodium-containing phosphate compounds that have a NASICON structure include NaₓM_{y}(PO₄)₃(1≤x≤2, 1≤y≤2, and M is at least one selected from the group consisting of Ti, Ge, Al, Ga, and Zr).

The solid electrolyte may include a sintering aid. The sintering aid included in the solid electrolyte may be selected from, for example, the same materials as the sintering aids, which can be included in the positive electrode layer/the negative electrode layer.

The thickness of the solid electrolyte layer is not particularly limited. The thickness of the solid electrolyte layer located between the positive electrode layer and the negative electrode layer may be, for example, 1 μm to 15 μm, particularly 1 μm to 5 μm.

(End-Face Electrode)

The solid-state battery 100 is typically provided with end-face electrodes 140. In particular, the solid-state battery 100 have side surfaces provided with end-face electrodes. More specifically, the side surfaces are provided with a positive-electrode-side end-face electrode 140A connected to the positive electrode layer 110 and a negative-electrode-side end-face electrode 140B connected to the negative electrode layer 120 (see FIG. 1). Such end-face electrodes preferably contain a material that is high in conductivity. The specific materials of the end-face electrodes are to be considered not particularly limited, but examples thereof include at least one selected from the group consisting of silver, gold, platinum, aluminum, copper, tin, and nickel.

[Basic Configuration of Solid-State Battery Package]

According to the present invention, the solid-state battery is packaged. More particularly, the solid-state battery package includes a mountable substrate, and has a configuration in which the solid-state battery is protected from the external environment.

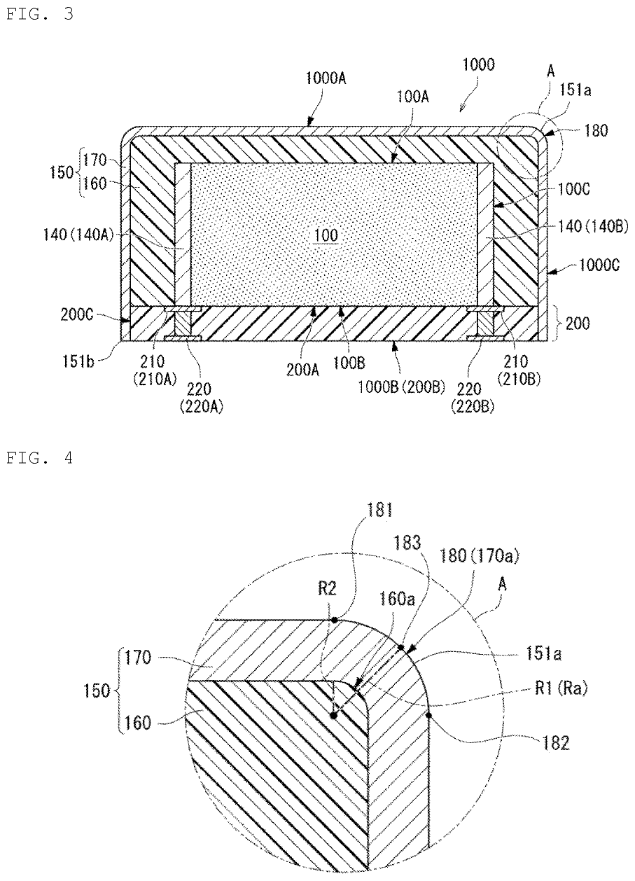

FIG. 2 is a perspective view schematically illustrating a solid-state battery package according to an embodiment of the present invention. In addition, FIG. 3 is a sectional view schematically illustrating the configuration of a solid-state battery package according to an embodiment of the present invention. As illustrated in FIG. 3, a solid-state battery package 1000 according to an embodiment of the present invention includes a substrate 200 so as to support the solid-state battery 100. Specifically, the solid-state battery package 1000 includes the mountable substrate 200 and the solid-state battery 100 provided on the substrate 200 and protected from the external environment.

As illustrated in FIG. 3, the substrate 200 has, for example, a larger main surface than the solid-state battery. The substrate 200 may be a resin substrate or a ceramic substrate. In short, the substrate 200 may fall in the category such as a printed wiring board, a flexible substrate, an LTCC substrate, or an HTCC substrate. When the substrate 200 is a resin substrate, the substrate 200 may be a substrate composed to include a resin as a base material, for example, a substrate that has a laminated structure including therein a resin layer. The resin material of such a resin layer may be any thermoplastic resin and/or any thermosetting resin. In addition, the resin layer may be formed by impregnating a glass fiber cloth with a resin material such as an epoxy resin, for example.

The substrate preferably serves as a member for an external terminal of the packaged solid-state battery. More particularly, the substrate can be also considered as a terminal substrate for an external terminal of the solid-state battery. The solid-state battery package provided with such a substrate can be mounted on another secondary substrate such as a printed wiring board, in such a form of interposing the substrate between the solid-state battery and the secondary substrate. For example, the solid-state battery can be mounted over a surface with the substrate interposed therebetween, through solder reflow and the like. For the reasons described above, the solid-state battery package according to the present invention is a surface-mount-device (SMD: Surface Mount Device) type battery package.

Such a substrate can be provided so as to support the solid-state battery, and can thus also be understood as a support substrate. In addition, the substrate preferably has, because of serving as a terminal substrate, a wiring, an electrode, and the like, and in particular, preferably includes an electrode layer that electrically connects upper and lower surfaces or upper and lower surface layers. More particularly, as illustrated in FIG. 3, the substrate may have a first main surface facing the solid-state battery and a second main surface located on the side opposite to the first main surface, and the electrode layer may electrically connect the first main surface and the second main surface. A substrate according to a preferred aspect includes a wiring or an electrode layer that electrically connects first and second surfaces of the substrate, and serves as a terminal substrate for an external terminal of a packaged solid-state battery. Such an aspect enables the wiring of the substrate to be used for extension from the solid-state battery to the external terminal, and thus requires no extension to the outside of an exterior part while packing with the exterior part described later, thereby increasing the design freedom of the external terminal.

The substrate 200 according to a preferred aspect includes electrode layers (upper main surface electrode layers 210 and lower main surface electrode layers 220) that electrically connects the upper and lower main surfaces of the substrate, and serves as a member for an external terminal of the packaged solid-state battery (see FIG. 3). In the solid-state battery package including such a substrate, the electrode layers of the substrate and terminal parts of the solid-state battery are connected to each other. Preferably, the electrode layers of the substrate and the end-face electrodes of the solid-state battery are electrically connected to each other. For example, the positive-electrode-side end-face electrode 140A of the solid-state battery is electrically connected to the positive-electrode-side electrode layers (210A, 220A) of the substrate. In contrast, the negative-electrode-side end-face electrode 140B of the solid-state battery is electrically connected to the negative-electrode-side electrode layers (210B, 220B) of the substrate. Thus, the positive-electrode-side and negative-electrode-side electrode layers (in particular, the electrode layers located on the lower side/bottom side of the packaged product, or lands connected thereto) of the substrate are provided respectively as a positive electrode terminal and a negative electrode terminal for the solid-state battery package.

For enabling electrical connection between the solid-state battery 100 and the substrate electrode layers 210 of substrate 200, the end-face electrodes 140 of solid-state battery 100 and the substrate electrode layer 210 of the substrate 200 can be connected with a joining member 600 interposed therebetween. The joining member 600 is responsible for at least electrical connection between the end-face electrodes 140 of the solid-state battery 100 and the substrate 200, and may include, for example, a conductive adhesive. As an example, the joining member 600 may be made of an epoxy-based conductive adhesive containing a metal filler such as μg.

Furthermore, according to an embodiment of the present invention, not only the substrate 200 but also the solid-state battery package 1000 itself can be configured to prevent water vapor permeation as a whole. For example, the solid-state battery package 1000 according to an embodiment of the present invention can be covered with an exterior part 150 such that the whole of the solid-state battery 100 provided on the substrate 200 is surrounded. Specifically, packaging can be performed such that the solid-state battery 100 on the substrate 200 have a main surface 100A and a side surface 100B surrounded by the exterior part 150. Such a configuration makes none of the surfaces that form solid-state battery 100 exposed to the outside, thus allowing water vapor permeation (that is, ingress of water vapor into the solid-state battery) to be suitably prevented.

It is to be noted that the term “water vapor” as used in the present specification is not particularly limited to water in a gaseous state, and also encompasses water in a liquid state and the like. More particularly, the term “water vapor” is used to broadly encompass water in a gaseous state, water in a liquid state, and the like, regardless of the physical state. Accordingly, the “water vapor” can also be referred to as moisture or the like, and in particular, the water in the liquid state can also encompass dew condensation water obtained by condensation of water in a gaseous state. The ingress of water vapor into the solid-state battery causes battery characteristics to be degraded, and thus, the form of the solid-state battery packaged as described above contributes to prolonging the life of the battery characteristics of the solid-state battery.

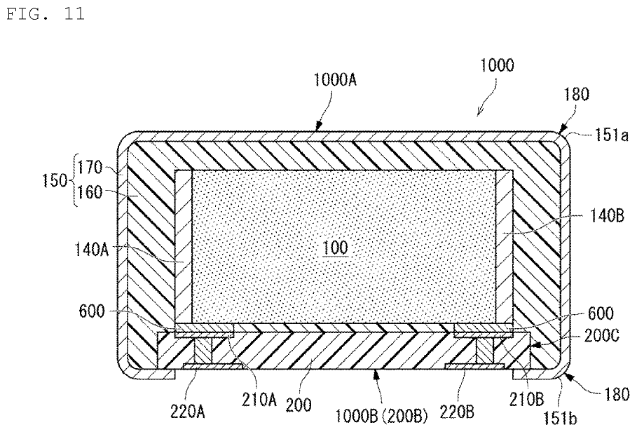

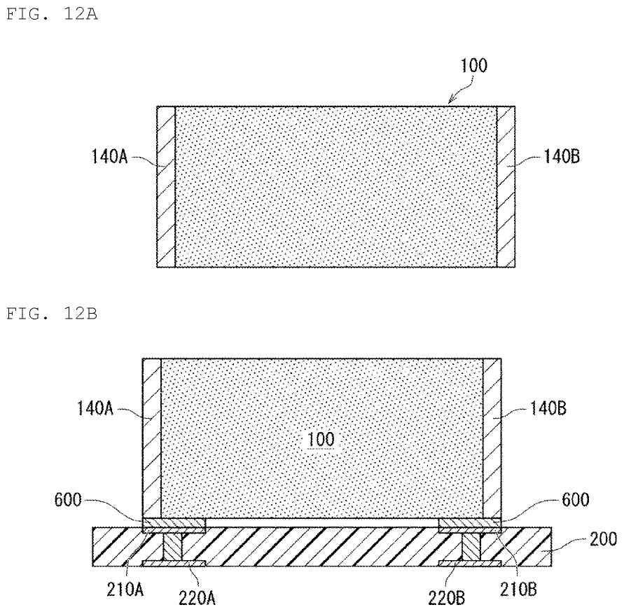

For example, as illustrated in FIG. 3, the exterior part 150 can be composed of a covering insulating layer 160 and a covering inorganic layer 170. The solid-state battery 100 may have a form covered with the covering insulating layer 160 and covering inorganic layer 170 as the exterior part 150. The covering inorganic layer 170 is provided so as to cover the covering insulating layer 160. The covering inorganic layer 170 is positioned on the covering insulating layer 160, and thus has the form of largely wrapping the solid-state battery 100 on the substrate 200 as a whole together with the covering insulating layer 160. Furthermore, the covering inorganic layer 170 may has the form of also covering a side surface 250 of the substrate 200. The covering insulating layer is formed so as to form a preferred water vapor barrier in cooperation with the covering inorganic layer, and the covering inorganic layer is also formed so as to form a preferred water vapor barrier in cooperation with the covering insulating layer. It is to be noted that the covering insulating layer may reach the side surfaces of the substrate. In other words, the covering insulating layer covering the top-surface region and side-surface region of the solid-state battery 100 may also cover the side surface of the substrate, and the covering inorganic layer may be provided on the covering insulating layer (see FIGS. 9 and 11).

The material of the covering insulating layer may be any type as long as the material exhibits an insulating property. For example, the covering insulating layer may include a resin, the resin may be either a thermosetting resin or a thermoplastic resin. The covering insulating layer may include an inorganic filler. By way of example only, the covering insulating layer may be made of an epoxy-based resin containing an inorganic filler such as SiC.

The material of the covering inorganic layer is not particularly limited, and may be, for example, a metal, glass, an oxide ceramic, or a mixture thereof. The covering inorganic layer may correspond to an inorganic layer that has the form of a thin film, which is, for example, a metal film. By way of example only, the covering inorganic layer may be made of a plated Cu-based and/or Ni-based material of 2 μm to 50 μm.

[Feature of Solid-State Battery Package according to Present Invention]

The inventor of the present application has intensively studied solutions for improving the resistance to mechanical stress from the outside to which the above-described solid-state battery package 1000 can be exposed, and as a result, has devised the present invention that has the following technical idea.

The present disclosure has the technical idea that “an exterior part that covers a solid-state battery has a structure including a curved surface”. More specifically, the present disclosure has the technical idea that “an end edge bent part of an exterior part has a structure including a curved surface curved outward”.

In this regard, the “end edge bent part” in the present specification means a part bent at an angle at an end edge in each surface region of the solid-state battery package, and can also be referred to as an “end edge corner” or an “end edge bent part”. Specifically, the “end edge bent part” encompass corners 151a, 151b and/or ridges 152 (see FIG. 1). It is to be noted that the “corner” refers to a part at which three or more adjacent surface regions extending in mutually different directions intersect. The “ridge” refers to a boundary part at which two adjacent surface regions extending in mutually different directions intersect, and may also be referred to as a “dihedral part” (see FIG. 1).

For achieving the technical idea mentioned above, the present disclosure has the following technical feature. As illustrated in FIGS. 1 and 3, the exterior part 150 provided so as to cover solid-state battery 100 includes multiple surface regions and multiple corners. According to an embodiment of the present invention, the exterior part 150 may include corners 151 that have a rounded outer shape including a curved surface. Specifically, among the multiple corners 151 of the exterior part 150, at least top surface-side corners 151a located on the side close to a top surface region 1000A of the solid-state battery package have an outward curved surface 180 curved outward.

The term “top surface region 1000A” as used in the present specification means a main surface region located relatively distally with respect to the substrate 200, among the surface regions constituting the solid-state battery package 1000. More specifically, assuming such a typical solid-state battery package that has two facing main surface regions, the “top surface region 1000A” as used in the present specification refers to one of the main surface regions, and particularly means a main surface region on the side opposite to a main surface region located to face the substrate (that is, a main surface region on the mounting surface side in the SMD type, which can also be referred to as a “bottom surface region” or a “lower surface region”). The “top surface region 1000A” can also be referred to as, for example, a “top surface region” or an “upper surface region”.

More particularly, the exterior part 150 according to the present disclosure can include at least the outward curved surface 180 at the top surface-side corners 151a located on the distal side with respect to the substrate 200 (see FIG. 3). In this regard, the “outward curved surface” in the present specification means a surface curved so as to protrude outward from the solid-state battery package 1000. More particularly, the top surface-side corners 151a of the exterior part 150 may have a rounded surface formed, which is curved so as to protrude outward from the solid-state battery package 1000. For example, the outward curved surface 180 may have a round chamfered shape obtained by chamfering the top surface-side corners 151a of the exterior part 150 into an arc shape.

For example, in the sectional view shown in FIG. 3, the top surface-side corners 151a including the outward curved surface 180 may include a substantially arc-shaped (that is, a convex arc-shaped) curve curved outward. In this regard, the term “substantially arc shape” as used in the present specification does not necessarily have to be a part of a perfect circle, and encompasses a part of an ellipse, and shapes along various smoothly curved curves such as a curve that can be approximated to the ellipse. More particularly, the “substantially arc-shaped curve” means a curve that has an arc shape in a macroscopic view, and may microscopically include a straight line, a bent line, and the like. Accordingly, the outward curved surface including the substantially arc-shaped curve in the sectional view is not necessarily a smooth curved surface, and may be a surface including irregular unevenness, undulation, and the like.

The top surface-side corners 151a located in the top surface region 1000A on the side opposite to a bottom surface region 1000B on which the solid-state battery package is mounted are susceptible to mechanical stress due to physical contact or the like from the outside also after mounting onto the substrate (see FIG. 1). Such a configuration allows the concentration of an unintended external force on the top surface-side corners 151a to be suitably avoided, and allows the top surface-side corners 151a to be kept from becoming any fracture starting part of the exterior part 150 if the solid-state battery package is exposed to mechanical stress from the outside. Specifically, with the exterior part 150 including the outward curved surface, the external force applied to the top surface-side corners 151a can be diffused to the whole curved surface without being locally concentrated, thus allowing damage to and breakages of the exterior part, caused by mechanical stress from the outside, to be more suitably suppressed. Thus, according to the present disclosure, the top surface-side corner including the outward curved surface keeps mechanical stress from the outside from being concentrated on the end edge bent part of the exterior part, and a solid-state battery package with further improved resistance to mechanical stress can be provided.

As described above, the exterior part contributes to preventing ingress of water vapor into the solid-state battery. The structure according to the present disclosure suitably suppresses breakages of the exterior part, caused by mechanical stress such as vibrations or physical contact at the time of transporting, mounting, or using the solid-state battery package, and as a result, the solid-state battery package function of preventing ingress of water vapor can be improved in function reliability. Furthermore, the structure according to the present disclosure can improve resistance to mechanical stress from the outside without increasing the thickness of the exterior part, and thus, can also suitably contribute to reducing the size of the solid-state battery package.

According to an embodiment, the exterior part 150 may also have a rounded outer shape at the ridges 152 (see FIG. 2). In particular, the exterior part 150 may include a surface curved outward such that the top surface-side ridges 152a positioned on the side close to top surface region 1000A are rounded. Specifically, the exterior part 150 may include the multiple top surface-side corners 151a, and the top surface-side ridges 152a connecting the adjacent top surface-side corners to each other among the multiple top surface-side corners 151a may include the outward curved surface. This means that the ridge 152a connecting the adjacent first top surface-side corner and second top surface-side corner includes the outward curved surface.

Such a top surface-side ridge 152a corresponds to a boundary part between the adjacent first surface region and second surface region extending in mutually different directions, and the outward curved surface of the top surface-side ridge 152a can also be understood as a surface extending from the first surface region to the second surface region. For example, as illustrated in FIG. 2, in an aspect of the exterior part 150 provided in the top surface region 1000A of the solid-state battery package and a side surface region 1000C thereof adjacent to the top surface region 1000A, the outward curved surface of the top surface-side ridge 152a may be formed so as to extend from the top surface region 1000A to the side surface region 1000C.

In such a configuration, the exterior part 150 may include the outward curved surface such that the end edge bent part located on the side close to the top surface region 1000A of the solid-state battery package is all rounded. More particularly, the exterior part 150 may have a structure where the top surface-side corners 151a and top surface-side ridges 152a located distally with respect to the substrate 200 each includes the outward curved surface. In accordance with such a configuration, the mechanical stress applied from the outside to the end edge bent part located on the top surface region side can be suitably dispersed by the outward curved surface. Accordingly, the mechanical stress from the outside is further kept from being concentrated on the end edge bent part to improve resistance to mechanical stress, and thus, the exterior part can be suitably prevented from being broken such as being cracked.

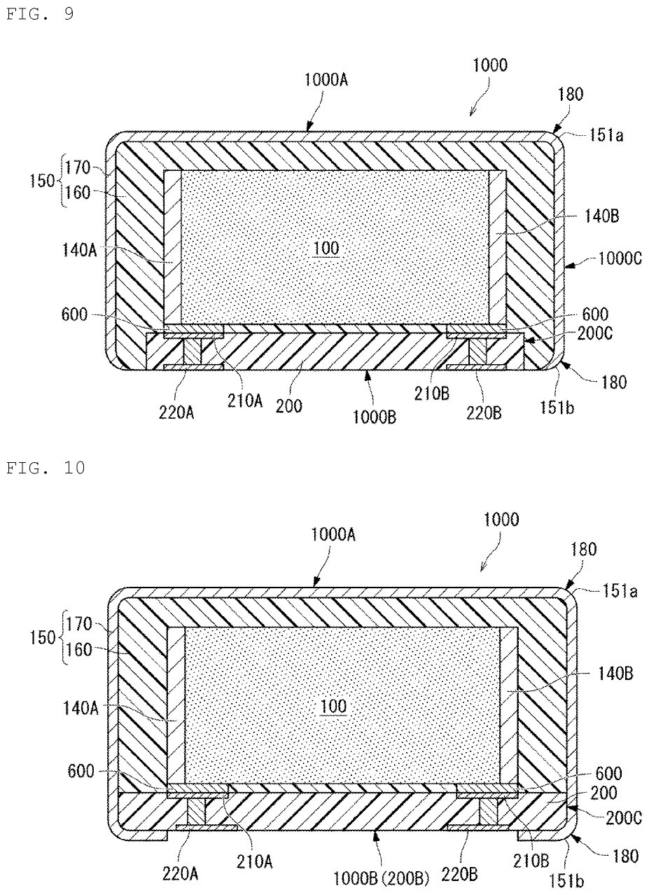

FIGS. 7 to 11 are sectional views schematically illustrating solid-state battery packages according to various embodiments of the present invention. In addition, FIG. 8 is an enlarged sectional view schematically illustrating a part B shown in FIG. 7. As illustrated, an exterior part 150 may extend so as to cover a side surface 200C connecting first and second main surfaces 200A and 200B of a substrate 200. The corner 151b of the exterior part 150, located on a corner 200b of the substrate, may have an outer shape curved so as to be rounded. Such a corner 151b is located on the side close to the bottom surface region 1000B located on the side opposite to the top surface region 1000A of the solid-state battery package, and can be referred to as a bottom surface-side corner 151b. Accordingly, as illustrated in FIG. 7, the exterior part 150 may have a structure where the bottom surface-side corner 151b at which the bottom surface region 1000B of the solid-state battery package intersects multiple side surface regions 1000C thereof includes an outward curved surface. The bottom surface-side corner 151b is likely to be exposed to mechanical stress due to contact, collision, or the like with another secondary substrate such as a printed wiring board, particularly in a process of mounting the solid-state battery package by a customer. Such a structure allows mechanical stress from the outside to be further kept from being concentrated on the corners, and the exterior part and the substrate inside the exterior part can be suitably prevented from being broken.

According to an embodiment of the present disclosure, the exterior part 150 may also have a rounded outer shape at bottom surface-side ridges 152b located on the side close to the bottom surface region 1000B of the solid-state battery package (see FIG. 2). Specifically, the top surface-side ridges 152b connecting the adjacent bottom surface-side corners to each other may include the outward curved surface. More particularly, the bottom surface-side ridge 152b connecting the adjacent first bottom surface-side corner and second bottom surface-side corner among the multiple bottom surface-side corners 151b may include the outward curved surface. Such a configuration can allow mechanical stress from the outside to the bottom surface region side of the solid-state battery package, which can be applied particularly in a process of mounting the solid-state battery package, to be further kept from being concentrated on the ridges. Accordingly, the present disclosure can provide a solid-state battery package with further improved resistance to mechanical stress from the outside.

In addition, according to another embodiment of the present invention, side surface-side ridges 152c of the exterior part 150, located on the side close to the side surface regions 1000C connecting the bottom surface region 1000B and top surface region 1000A of the solid-state battery package 1000 may also have a rounded outer shape (see FIGS. 2 and 3). Specifically, the side surface-side ridges 152c connecting the top surface-side corners 151a and bottom surface-side corners 151b of the exterior part 150 may include the outward curved surface. This means that the outward curved surface extends from one side surface region to the other side surface region at the side surface-side ridge 152c as a boundary part between the two mutually adjacent side surface regions 1000B of the exterior part 150. In accordance with such a configuration, a solid-state battery package can be provided, which is capable of also keeping mechanical stress from the outside to the side surface region side of the solid-state battery package from being concentrated on the ridges.

As illustrated in FIG. 3, according to the present disclosure, the exterior part 150 is provided so as to cover end-face electrodes 140 provided on side surfaces 100C of solid-state battery 100. In other words, the end-face electrodes 140 are covered with the exterior part 150 without being exposed to the outside. Thus, the exterior part 150 according to the present disclosure suitably protects the end-face electrodes 140 against mechanical stress from the external environment, thereby contributing to preventing ingress of water vapor from the sides with the end-face electrodes 140 into solid-state battery 100. More particularly, such a structure protects the end-face electrodes 140 more suitably as compared with a case where the end-face electrodes 140 are exposed to the outside. Furthermore, the water vapor ingress prevention of the solid-state battery 100 can also be improved, and a more reliable solid-state battery package can be thus provided. Furthermore, for the solid-state battery package according to the present disclosure, the exterior part 150 also includes the outward curved surface at the side surface-side ridges 152c (see FIG. 2) covering the end-face electrodes 140 as described above. Thus, the influence of mechanical stress from the outside on the end-face electrodes 140 is further alleviated, and a solid-state battery package that is better in resistance to mechanical stress can be provided.

Furthermore, as illustrated in FIG. 3, the solid-state battery 100 according to the present disclosure may have a rectangular shape in a sectional view. More particularly, the solid-state battery 100 covered with the exterior part 150 including the outward curved surface described above may have a rectangular shape in a sectional view. More particularly, in solid-state battery package 1000 according to the present disclosure, the end edge bent part of the solid-state battery 100 may be angular so as to be bent substantially at 90 degrees, and the exterior part 150 covering the solid-state battery 100 may have a rounded shape including the outward curved surface at the end edge bent part. The exterior part 150 has a rounded shape as described above, and thus, the solid-state battery 100 that has an angular shape can be suitably protected against mechanical stress from the outside. More particularly, according to the present disclosure, covering the solid-state battery 100 with the rounded exterior part allows resistance to mechanical stress from the outside to be improved, if the solid-state battery has an angular shape that is relatively likely to be affected by mechanical stress. In addition, as compared with a case where the solid-state battery 100 itself has a shape chamfered to be rounded, the solid-state battery 100 according to the present disclosure, which has a rectangular shape (that is, a non-chamfered shape) in a sectional view, has a larger battery volume, and thus can be higher in capacity. Accordingly, according to the present disclosure, a high-capacity solid-state battery package with further improved resistance to mechanical stress from the outside can be provided.

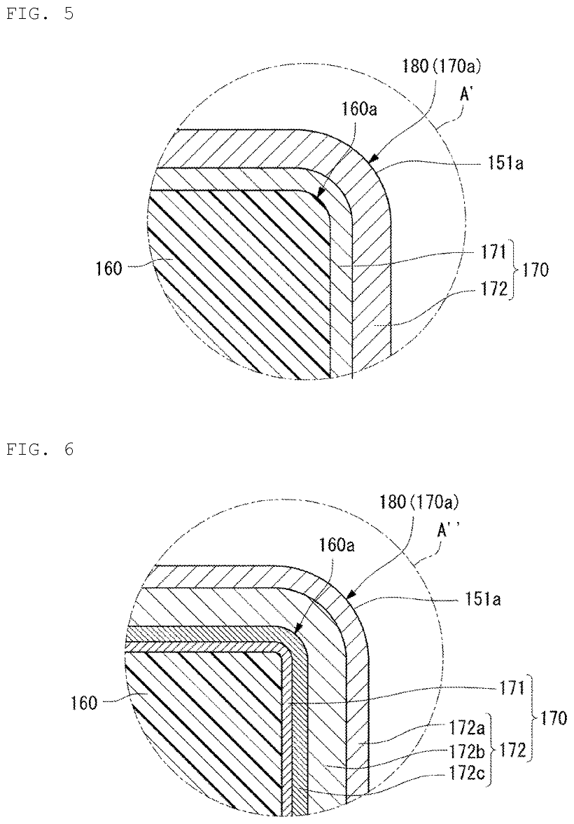

FIG. 4 is an enlarged sectional view schematically illustrating a part A including the outward curved surface in the solid-state battery package shown in FIG. 3. As described above, the exterior part 150 includes: the covering insulating layer 160 covering the solid-state battery 100 on the substrate; and the covering inorganic layer 170 provided on the covering insulating layer 160. At least the covering inorganic layer 170 that forms the outermost layer of the solid-state battery package may be rounded at the end edge bent part of the exterior part 150 including the outward curved surface 180. More specifically, the outward curved surface 180 of the end edge bent part of the exterior part 150 corresponds to the curved surface of the covering inorganic layer 170 as the outermost layer of the exterior part 150, and thus, can also be referred to as a curved inorganic surface 170a.

In other words, the curved inorganic surface 170a may be the outer surface of the covering inorganic layer 170 as the outermost layer of the exterior part 150. More particularly, the curved inorganic surface 170a may be a part of the outer surface of the covering inorganic layer 170 that defines the outer contour of the solid-state battery package. When at least the covering inorganic layer 170 located on the outermost of the exterior part 150 includes the curved inorganic surface 170a curved outward, the influence of mechanical stress received from the outside can be alleviated. Thus, mechanical stress from the outside can be more suitably kept from being concentrated on the end edge bent part. As a result, the solid-state battery package according to the present disclosure can contribute to improving the resistance of the exterior part to mechanical stress from the outside as a whole.

As illustrated in FIG. 4, in a sectional view, the covering insulating layer 160 may include a curved insulating surface 160a curved outward at the end edge bent part of the exterior part 150 including the outward curved surface. More particularly, the covering insulating layer 160 located inside the curved inorganic surface 170a may also be curved outward. In other words, the curved inorganic surface 170a may be provided on the curved insulating surface 160a. This means that at the end edge bent part of the exterior part 150 including the outward curved surface 170a, the covering insulating layer 160 and covering inorganic layer 170 constituting the exterior part 150 both include surfaces curved so as to protrude outward.

According to such an embodiment, the covering inorganic layer 170 can be curved in a band shape in a sectional view, and the covering insulating layer 160 may be curved along the shape of the inner surface of the covering inorganic layer 170. In other words, the covering inorganic layer 170 may be curved in a band shape along the outward curved surface of the covering insulating layer 160. In addition, as illustrated in FIGS. 7 and 8, according to an aspect in which only the covering inorganic layer 170 is provided so as to cover the side surfaces of the substrate, the substrate 200 located inside the curved inorganic surface 170b on the side close to the bottom surface region 1000B may also be curved outward. Specifically, the ridges and corners 200b of the substrate 200 located inside the exterior part 150 may be curved outward so as to be rounded. According to such an embodiment, the substrate may be curved along the shape of the inner surface of the covering inorganic layer 170 curved outward. More particularly, in a sectional view, the covering inorganic layer 170 may be curved in a band shape along the curved surface of the substrate 200. This can also be understood as the fact that the curved inorganic surface 170b included in the covering inorganic layer 170 has a shape curved so as to follow the shape of the curved surface of the substrate 200.

In accordance with such a configuration, not only the outermost layer but also the covering insulating layer 160 and/or the substrate 200 located on the inner side include the curved surface, and thus, mechanical stress from the outside can be kept from being concentrated on the end edge bent part of the covering insulating layer 160 and/or the substrate 200. The mechanical stress applied to the covering inorganic layer 170 from the outside can be more effectively diffused by the curved surface provided for both the covering inorganic layer 170 and covering insulating layer 160 constituting the exterior part 150 and/or the substrate 200. For the reason, a solid-state battery package can be provided in which mechanical stress is suitably kept from being concentrated on the end edge bent part to further improve the resistance to mechanical stress from the outside.

In addition, the above-described configuration can also keep the exterior part from being broken due to the expansion and shrinkage of the solid-state battery in charging and discharging the battery. Specifically, due to the expansion and shrinkage, stress can act on the exterior part from the solid-state battery side. The end edge bent part of the exterior part is likely to have stress concentrated thereon and also inferior in strength to other parts, and is thus likely to be affected by stress caused by the expansion and shrinkage. The covering insulating layer has a shape curved outward together with the covering inorganic layer, and thereby can make it possible to alleviate stress that acts on the end edge bent part of the exterior part from the solid-state battery described above.

In addition, according to an embodiment, the covering inorganic layer 170 may extend from on the side surfaces 200C of the substrate, further to the second main surface 200B of the substrate, located on the side with the bottom surface region 1000B of the solid-state battery package (see FIG. 10). More particularly, the covering inorganic layer 170 may extend beyond the side surfaces 200C of the substrate to the second main surface 200B of the substrate. In such a configuration, the curved inorganic surface 170b located on the side close to the bottom surface region 1000B of the solid-state battery package may wrap further around the second main surface 200B of the substrate so as to cover the end edge bent part located on the side close to the second main surface 200B of the substrate. In other words, the corners 200b and ridges located on the side close to the second main surface 200B of the substrate may be covered with the curved inorganic surface 170b. The curved inorganic surface is provided so as to cover the end edge bent part of the substrate, thereby allowing the end edge bent part of the substrate to be more effectively protected against mechanical stress that can be applied from the side with the bottom surface of the solid-state battery package.

In addition, as illustrated in FIG. 9, the covering insulating layer 160 may reach the side surfaces 200C of the substrate. In the case of such a form, the covering insulating layer 160 covering the side surfaces 200C of the substrate may include a curved surface at the end edge bent part located on the side close to the bottom surface region 1000B of the solid-state battery package, and the curved inorganic surface 170b may be provided on such a curved surface. Furthermore, as illustrated in FIG. 11, the covering inorganic layer 170 may extend from on the covering insulating layer 170, further to the second main surface 200B of the substrate. Such a structure relatively increases the joint area between the substrate 200 and the exterior part 150, thereby making the exterior part 150 less likely to be peeled. In addition, covering the boundary between the substrate 200 and the covering insulating layer 160 with the covering inorganic layer 170 more suitably prevents ingress of such water vapor from the outside to the solid-state battery 100, and can allow the end edge bent part of the substrate to be also protected.

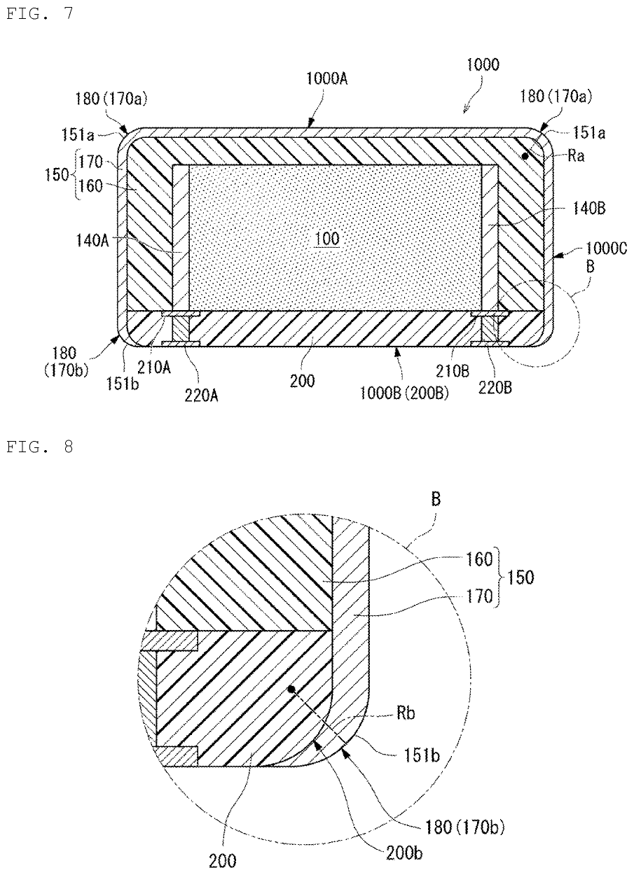

In addition, as illustrated in FIGS. 5 and 6, the covering inorganic layer 170 included in the exterior part 150 may have a structure including two or more layers. More particularly, the covering inorganic layer 170 provided on the covering insulating layer 160 may be a composite inorganic film that has two or more inorganic layers laminated.

According to an embodiment, the covering inorganic layer 170 may include a dry plating film 171 and a wet plating film 172. More particularly, a composite inorganic film composed of the dry plating film 171 and the wet plating film 172 may be provided on the covering insulating layer 160. The dry plating film 171 may be, for example, a sputtered film. More particularly, the solid-state battery package according to the present invention may be provided with a sputtering thin film as a dry plating film. The sputtered film is a thin film obtained by sputtering. More particularly, a film obtained by sputtering ions onto a target to eject and deposit atoms thereof can be used as the dry plating film.

This sputtered film becomes a relatively dense and/or homogeneous film while having a significantly thin nano-order or micro-order form, and thus can contribute to preventing water vapor permeation to the solid-state battery. In addition, the sputtered film is formed by atomic deposition, and can be thus more suitably attached onto the target. Thus, the sputtered film can be more suitably provided as a barrier for preventing water vapor in the external environment from entering the solid-state battery. Thus, the covering inorganic layer further includes the sputtered film as a dry plating film, thereby allowing the prevention of water vapor permeation to the solid-state battery to be further improved. It is to be noted that the dry plating film may be formed by another dry plating, such as a vacuum deposition method or an ion plating method. According to a preferred aspect, the dry plating film may contain, for example, at least one selected from the group consisting of Al (aluminum), Cu (copper), Ti (titanium), and stainless steel (SUS).

The wet plating film 172 may be a single layer, or may have a multilayer structure of two or more layers as illustrated in FIG. 6. According to a preferred aspect, the covering inorganic layer 170 may include the dry plating film 171 and multiple wet plating films 172 (172a to 172c), and the dry plating film 171 and the multiple wet plating films 172a to 172c may be laminated on the covering insulating layer 160. While FIG. 6 exemplarily illustrates, but not limited to, an embodiment including a three-layer wet plating film, and for example, a two-layer, three-layer, or four-layer wet plating film may be formed. More particularly, the covering inorganic layer 170 may be a composite inorganic film that has a multilayer structure of three or more layers including a dry plating film and a wet plating film. With such multiple wet plating films 172 provided on the dry plating film 171, the covering inorganic layer 170 can function more suitably as a barrier that prevents ingress of such water vapor from the outside to the solid-state battery.

By way of example only, the wet plating film may include, for example, plating of one metal selected from the group consisting of Cu (copper), Ni (nickel), Sn (tin), Pb (lead), Au (gold), Ag (silver), Pd (palladium), Bi (bismuth), Cr (chromium), and Zn (zinc), or an alloy containing at least one metal of the group.

Each of the multiple wet plating films 172a to 172c may be a different type of metal plating film. Alternatively, two types of metal plating films may be alternately formed. According to an aspect, the composite inorganic film includes a plating film with relatively high ductility and a plating film with corrosion resistance. As described above, with the laminated plating films that have different properties from each other, the composite inorganic film has stress relaxed by the plating film with high ductility, and the mechanical deterioration of the composite inorganic film due to the influence of the external environment can be suppressed by the plating film with corrosion resistance. For example, the covering inorganic layer may be, on the dry plating film, a multilayer film obtained by laminating a wet plating film containing Cu as a main component with relatively high ductility and a wet plating film containing Ni as a main component with relatively high corrosion resistance in an arbitrary order.

As described above, when the covering inorganic layer 170 is a composite inorganic film including two or more inorganic films, each of the inorganic films may be curved outward at the outward curved surface of the exterior part 150. More particularly, two or more inorganic films curved outward at the outward curved surface may be laminated in a sectional view. In such a form, the sectional shapes of the inorganic films included in the composite inorganic film may have a similarity relationship with each other. As described above, the solid-state battery package includes the two or more inorganic films curved outward at the end edge bent part, thereby diffusing mechanical stress from the outside at the curved surface of each inorganic film. Thus, the concentration of mechanical stress from the outside on the end edge bent part is enabled to be more effectively avoided, and the resistance of the solid-state battery package to mechanical stress can be further improved.

The stress concentration on the end edge bent part can be more relaxed with the increased radius of curvature of the outward curved surface. In contrast, when the radius of curvature is increased, the thickness of the exterior part at the end edge bent part is relatively reduced, and the function as a water vapor barrier may be deteriorated. When emphasis is placed on both the relaxation of the stress concentration and the water vapor barrier property secured, the radius of curvature of the outward curved surface in a sectional view is preferably 35 μm to 250 μm, more preferably 40 μm to 200 μm, still more preferably 50 μm to 175 μm. The radius of curvature falls within the range mentioned above, thereby making it possible to obtain a solid-state battery package where mechanical stress from the outside is suitably kept from being concentrated on the end edge bent part of the exterior part.

The “radius of curvature” in the present specification means a radius of a circle that is obtained when a part of the curve included in the outward curved surface at the outermost surface of the exterior part 150 is approximated to an arc in a sectional view. More particularly, the “radius of curvature” means a radius as an arc in the shape of the outermost edge (that is, the outermost contour) of the outward curved surface in a sectional view. For example, in the sectional view illustrated in FIG. 4, the radius of curvature can be determined with the use of a known mathematical method from three points: the start point 181 and end point 182 of the curvature; and a central bending point 183 located between the start point and the end point, in the curve included in the outermost edge of the outward curved surface. As illustrated in FIG. 4, when the exterior part 150 includes the covering inorganic film 170 for the outermost layer, the radius of curvature of the outward curved surface corresponds to the radius of curvature R1 (see FIG. 4) of the curved inorganic surface that defines the outermost edge of the exterior part 150.

The structure of the solid-state battery package in the present specification may be observed from an image acquired by cutting out a section in a sectional view direction with an ion milling apparatus (model number: SU-8040 manufactured by Hitachi High-Tech Corporation) and using a microscope (model number: VHX-6000 manufactured by KEYENCE CORPORATION). In addition, the radius of curvature and thickness dimension used in the present specification may refer to values calculated from dimensions measured from an image acquired by the method described above.

The radius of curvature of the outward curved surface at the corner and the radius of curvature of the outward curved surface at the ridge may be different from each other. According to an embodiment, the radius of curvature of the outward curved surface at the corner is larger than the radius of curvature of the outward curved surface at the ridge. According to such an embodiment, each of the curved inorganic surface and curved insulating surface located at the top surface-side corners 151a and the bottom surface-side corners 151b may have a larger radius of curvature than the curved inorganic surface and curved insulating surface at the top surface-side ridges 152a, the bottom surface-side ridges 152b, and the bottom surface-side ridges 152c (see FIG. 1).

The corners are likely to have stress concentrated as compared with the ridges, and likely to be broken due to mechanical stress from the outside. As described above, including the outward curved surface where the corner has a larger radius of curvature than the ridge can more suitably alleviate stress concentration at the corner, and more suitably keep the exterior part from being broken at the corner.

In addition, according to an embodiment, the respective radii of curvature R1 and R2 of the covering insulating layer 160 and covering inorganic layer 170 at the outward curved surface may be the same or different from each other (see FIG. 4). For example, the curved insulating surface 160a of the covering insulating layer and the curved inorganic surface 170a provided thereon may have different radii of curvature from each other. According to a preferred aspect, the radius of curvature R1 of the curved inorganic surface may be larger than the radius of curvature R2 of the curved insulating surface located inside the curved inorganic surface. The covering inorganic layer 170 may have a constant thickness in a sectional view from appropriate setting such that the curved inorganic surface 170a located on the outer side has a larger radius of curvature. More specifically, in a sectional view, the covering inorganic layer 170 may be provided to have a constant thickness on the covering insulating layer 160. This means that the covering inorganic layer 170 is provided in a band shape with a constant width on the covering insulating layer 160 at the end edge bent part in a sectional view. Such a configuration can avoid the generation of a site where a part of the covering inorganic layer 170 is thinner at the end edge bent part. Thus, a solid-state battery package can be provided, which is capable of more suitably keeping the covering inorganic layer from being broken due to mechanical stress from the outside.

In a sectional view, the radius of curvature of the outward curved surface at the corner (corresponding to the radius of curvature Ra of the curved inorganic surface) is preferably 120 μm to 250 μm, more preferably 130 μm to 240 μm, still more preferably 140 μm to 230 μm. The radius of curvature of the corner falls within the range mentioned above, thereby making it possible to obtain a solid-state battery package where mechanical stress from the outside is suitably kept from being concentrated.

In addition, in a sectional view, the radius of curvature of the outward curved surface at the ridge (corresponding to the radius of curvature Ra of the curved inorganic surface) is preferably 80 μm to 200 μm, more preferably 85 μm to 180 μm, still more preferably 90 μm to 150 μm. The radius of curvature of the ridge falls within the range mentioned above, thereby making it possible to obtain a solid-state battery package where mechanical stress from the outside is suitably kept from being concentrated.

Furthermore, in a sectional view, the radius of curvature R2 of the curved insulating surface located inside the curved inorganic surface at the corner is preferably 45 μm to 150 μm, more preferably 50 μm to 140 μm, still more preferably 55 μm to 130 μm. The radius of curvature of the curved insulating surface at the corner falls within the range mentioned above, thereby making it possible to obtain a solid-state battery package where mechanical stress from the outside is suitably kept from being concentrated.

In addition, in a sectional view, the radius of curvature R2 of the curved insulating surface located inside the curved inorganic surface at the ridge is preferably 35 μm to 120 μm, more preferably 40 μm to 100 μm, still more preferably 45 μm to 80 μm. The radius of curvature of the curved insulating surface at the ridge falls within the range mentioned above, thereby making it possible to obtain a solid-state battery package where mechanical stress from the outside is suitably kept from being concentrated.

According to an embodiment, the end edge bent part of the exterior part 150, located on the side close to the top surface region 1000A of the solid-state battery package may include an outward curved surface that has a different radius of curvature from the end edge bent part located on the side close to the bottom surface region 1000B. For example, the radius of curvature Ra of the outward curved surface at the top surface-side corner 151a may be larger than the radius of curvature Rb of the outward curved surface at the bottom surface-side corner 151b (see FIGS. 7 and 8). The top surface region 1000A of the solid-state battery package may be exposed to the outside also after mounting the solid battery package, and may be thus possibly relatively susceptible to mechanical stress such as contact with another component. The end edge bent part located on the side close to the top surface region 1000A of the solid-state battery package preferably includes an outward curved surface that has a larger radius of curvature for avoiding the concentration of mechanical stress from the outside. In contrast, the outward curved surface of the end edge bent part located on the bottom surface region side has a smaller radius of curvature than the top surface region side, thereby increasing the area of contact between a mounting substrate and the solid-state battery package, and allowing the connection between the solid-state battery package and the mounting substrate to be further strengthened.

[Method for Manufacturing Solid-state Battery Package]

The objective product according to the present invention can be obtained through a process of preparing a solid-state battery that includes a battery constituent unit including a positive electrode layer, a negative electrode layer, and a solid electrolyte between the electrodes and next packaging the solid-state battery.

The manufacture of the solid-state battery according to the present invention can be roughly divided into: manufacture of a solid-state battery itself (hereinafter, also referred to as an “unpackaged battery”) corresponding to a stage prior to packaging; preparation of a substrate; and the packaging.

<<Method for Manufacturing Unpackaged Battery>>

An unpackaged battery can be manufactured by a printing method such as screen printing, a green sheet method with a green sheet used, or a combined method thereof. More particularly, the unpackaged battery itself may be fabricated in accordance with a conventional method for manufacturing a solid-state battery (thus, for raw materials such as the solid electrolyte, organic binder, solvent, optional additives, positive electrode active material, and negative electrode active material described below, those for use in the manufacture of known solid-state batteries may be used).

Hereinafter, for better understanding of the present invention, one manufacturing method will be exemplified and described, but the present invention is not limited to this method. In addition, the following time-dependent matters such as the order of descriptions are merely considered for convenience of explanation and are not necessarily bound by the matters.

(Formation of Stack Block)

The solid electrolyte, the organic binder, the solvent, and optional additives are mixed to prepare a slurry. Then, from the prepared slurry, sheets including the solid electrolyte are formed by firing.

The positive electrode active material, the solid electrolyte, the conductive material, the organic binder, the solvent, and optional additives are mixed to prepare a positive electrode paste. Similarly, the negative electrode active material, the solid electrolyte, the conductive material, the organic binder, the solvent, and optional additives are mixed to prepare a negative electrode paste.

The positive electrode paste is applied by printing onto the sheet, and a current collecting layer and/or a negative layer are applied by printing, if necessary. Similarly, the negative electrode paste is applied by printing onto the sheet, and a current collecting layer and/or a negative layer are applied printing, if necessary.

The sheet with the positive electrode paste applied by printing and the sheet with the negative electrode paste applied by printing are alternately stacked to obtain a stacked body. Further, the outermost layer (the uppermost layer and/or the lowermost layer) of the stacked body may be the electrolyte layer, an insulating layer, or an electrode layer.

(Formation of Battery Fired Body)

The stacked body is integrated by pressure bonding, and then cut into a predetermined size. The cut stacked body obtained is subjected to degreasing and firing. Thus, a fired laminate was obtained. It is to be noted that the stacked body may be subjected to degreasing and firing before cutting the stacked body, and then cut.

(Formation of End-Face Electrode)

The end-face electrode on the positive electrode side can be formed by applying a conductive paste to the positive electrode exposed side surface of the fired laminate. Similarly, the end-face electrode on the negative electrode side can be formed by applying a conductive paste to the negative electrode exposed side surface of the fired laminate. The end-face electrodes on the positive electrode side and the negative electrode side may be provided so as to extend to a main surface of the fired laminate. The component for the end-face electrodes can be selected from at least one selected from silver, gold, platinum, aluminum, copper, tin, or nickel.

Further, the end-face electrodes on the positive electrode side and the negative electrode side are not limited to being formed after firing the stacked body, and may be formed before the firing and subjected to simultaneous firing.

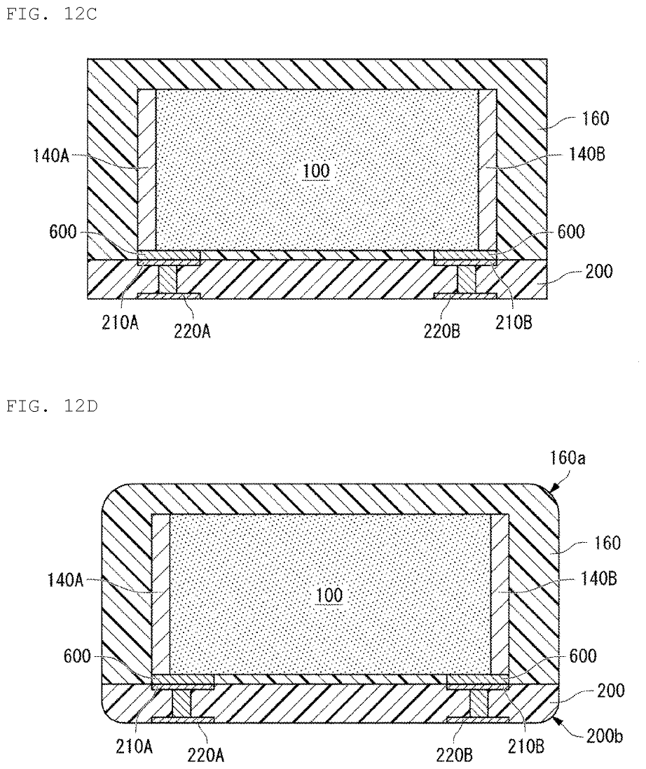

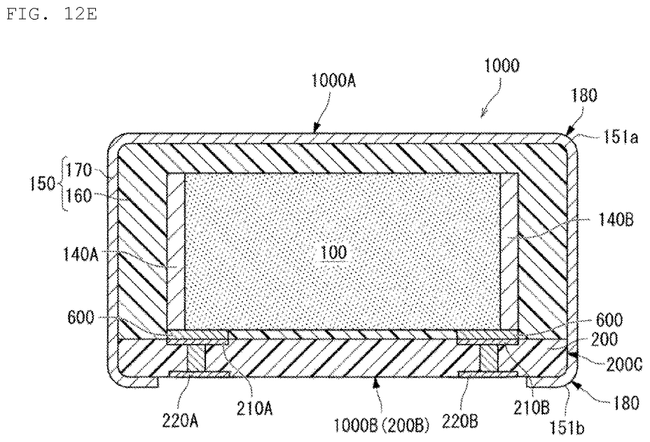

Through the steps described above, a desired unpackaged battery (corresponding to the solid-state battery 100 shown in FIG. 12A) can be finally obtained.

<<Preparation of Substrate>>

In this step, a substrate is prepared.

Although not particularly limited, in the case of using a resin substrate as the substrate, the substrate may be prepared by laminating multiple layers and then performing heating and pressurizing treatments for the layers. For example, a substrate precursor is formed with the use of a resin sheet made by impregnating a fiber cloth as a substrate with a resin raw material. After the formation of the substrate precursor, the substrate precursor is subjected to heating and pressurization with a press machine. In contrast, in the case of using a ceramic substrate as the substrate, for the preparation thereof, for example, multiple green sheets can be subjected to thermal compression bonding to form a green sheet laminate, and the green sheet laminate can be subjected to firing, thereby providing a ceramic substrate. The ceramic substrate can be prepared, for example, in accordance with the preparation of an LTCC substrate. The ceramic substrate may have vias and/or lands. In such a case, for example, holes may be formed for the green sheet with a punch press, a carbon dioxide gas laser, or the like, and filled with a conductive paste material, or a conductive part precursor such as vias, lands, and wiring layers may be formed through implementation of a printing method or the like. Further, lands and the like can also be formed after firing the green sheet laminate.

Through the steps described above, the desired substrate 200 can be finally obtained.

<<Packaging>>

Next, packaging is performed with the use of the battery and substrate obtained as mentioned above (see FIGS. 12B to 12E).

First, the unpackaged battery 100 is placed on the substrate 200 (see FIG. 12B). More particularly, the “unpackaged solid-state battery” is placed on the substrate (hereinafter, the battery used for packaging is also simply referred to as a “solid-state battery”).

Preferably, the solid-state battery 100 is placed on the substrate so as to electrically connect the conductive parts of the substrate and the end-face electrodes of the solid-state battery 100 to each other. For example, a conductive paste may be provided on the substrate, thereby electrically connect the conductive parts of the substrate and the end-face electrodes of the solid-state battery 100 to each other. More specifically, alignment is performed such that the conductive parts (in particular, lower land/bottom land) on the positive electrode side and negative electrode side of the main surface of the substrate are respectively matched with the end-face electrodes of the positive electrode and negative electrode of the solid-state battery 100, and the parts and the electrodes are bonded and electrically connected with the use of a conductive paste (for example, Ag conductive paste). More particularly, a precursor for a joining member that is responsible for electrical connections between solid-state battery 100 and the substrate may be provided in advance.

such a precursor for a joining member can be provided by printing with a conductive paste that requires no flux cleaning or the like after the formation, such as a nano-paste, an alloy-based paste, or a brazing material, in addition to the Ag conductive paste. Subsequently, the solid-state battery 100 is placed on the substrate such that the end-face electrodes of the solid-state battery and the precursor of the joining member are brought into contact with each other, and subjected to a heating treatment, thereby forming, from the precursor, the joining member that contributes to electrical connections between the solid-state battery 100 and the substrate.

Next, the exterior part 150 is formed. As the exterior part, the covering insulating layer 160 and the covering inorganic layer 170 are provided.

First, the covering insulating layer 160 is formed so as to cover the solid-state battery 100 on substrate 200 (see FIG. 12C). Hence, a raw material for the covering insulating layer is provided such that the solid-state battery 100 on the substrate is totally covered. When the covering insulating layer is made of a resin material, a resin precursor is provided on the substrate and subjected to curing or the like to mold the covering insulating layer. According to a preferred embodiment, the covering insulating layer may be molded by pressurization with a mold. By way of example only, a covering insulating layer for sealing the solid-state battery 100 on the substrate may be molded through compression molding. In a case of a resin material generally for use in molding, the form of the raw material for the covering insulating layer may be granular, and the type thereof may be thermoplastic. It is to be noted that such molding is not limited to die molding, and may be performed through polishing, laser processing, and/or chemical treatment.

After molding the covering insulating layer 160, corners and/or ridges of the covering insulating layer 160 and/or substrate 200 are rounded to form the outward curved surface 180 (see FIG. 12D). Specifically, “the covering precursor with the individual solid-state battery 100 covered with the covering insulating layer 160 on the substrate 200” is subjected to processing for forming the outward curved surface. By way of example only, examples of the processing method include multiple means including a grinding treatment with a barrel or a sandblasting treatment. Such processing is more preferably performed with the use of an organic solvent. In addition, a cleaning step may be included after the processing.

For example, the covering precursor after the formation of the covering insulating layer 160 may be sealed in a barrel together with a grinding medium that is higher in hardness than the covering insulating layer 160 and/or the substrate 200, and an organic solvent, and polished by rotating the barrel. By way of example only, examples of the grinding media for use in such a grinding treatment include alumina powders and/or alumina balls. In a preferred aspect, the covering precursor may be, together with grinding media and an organic solvent, put into a barrel container and rotated at about 100 RPM for about 10 hours. Such barrel polishing provides curved roundness to the covering insulating layer 160 and/or substrate 200 located at the end edge bent part of the solid-state battery package. In addition, the covering precursor subjected to the barrel polishing may be subjected to ultrasonic cleaning with the use of an organic cleaning solvent, and then dried.

After the formation of the outward curved surface, the covering inorganic layer 170 is formed (see FIG. 12E). The covering inorganic layer 170 may be formed by plating the covering precursor. Thus, the covering inorganic layer 170 can be formed to follow the outer shape of the covering insulating layer 160. More particularly, the covering inorganic layer 170 formed by plating has a shape including a curved surface following the outer contour of the curved surface of the covering insulating layer 160 and/or substrate 200, provided by barrel polishing or the like. According to an embodiment, multiple wet plating films are formed on the exposed surfaces other than the bottom surface of the covering precursor (that is, other than the bottom surface of the substrate), thereby forming a composite inorganic film on the covering precursor.

The wet plating composite layer may be formed by laminating multiple wet plating films by performing wet plating processes that differ in property in a predetermined order. For example, according to an embodiment of the present invention, the covering precursor is subjected to multiple types of wet plating in order, and thereby provided with a first wet plating film and a second wet plating film laminated in this order.

The wet plating can be performed by, for example, electroplating or electroless plating. When emphasis is placed on the film-forming rate of the plating, the wet plating films are more preferably formed by electroplating. Thus, according to an embodiment of the present invention, the wet plating films can be formed by electroplating, and thus, the wet plating films can also be referred to as electroplating films.

In addition, in the formation of the covering inorganic layer, dry plating and wet plating may be combined. For example, the covering precursor may be first subjected to dry plating to form a dry plating film. More specifically, a dry plating film may be formed by dry plating on the exposed surfaces other than the bottom surface of the covering precursor (that is, other than the bottom surface of the support substrate). Subsequently, the covering precursor with the dry plating film formed may be subjected to multiple types of wet plating in a predetermined order to form a wet plating composite layer on the dry plating film.

Through the steps as described above, a package product can be obtained, where the solid-state battery on the substrate is totally covered with the covering insulating layer and the covering inorganic layer, with the outward curved surface included at the end edge bent part. More particularly, the “solid-state battery package” according to the present invention can be finally obtained.

Further, the substrate may have a water vapor barrier layer formed. More particularly, a water vapor barrier may be formed for the substrate, prior to the packaging of combining the substrate and the solid-state battery.

The water vapor barrier layer is not particularly limited as long as a desired barrier layer can be formed. For example, in the case of “a water vapor barrier layer having a Si—O bond and a Si—N bond”, the water vapor barrier layer is preferably formed through application of a liquid raw material and ultraviolet irradiation. More particularly, the water vapor barrier layer is formed under a relatively low temperature condition (for example, a temperature condition on the order of 100° C.) without using any vapor-phase deposition method such as CVD or PVD.

Specifically, a raw material containing, for example, silazane is prepared as the liquid raw material, and the liquid raw material is applied to the substrate by spin coating, spray coating, or the like, and dried to form a barrier precursor. Then, the barrier precursor can be subjected to UV irradiation in an environmental atmosphere containing nitrogen, thereby providing a “water vapor barrier layer having a Si—O bond and a Si—N bond”.

It is to be noted that the barrier layer at the joint sites between the conductive parts of the substrate and the end-face electrodes of the solid-state battery is preferably locally removed such that the water vapor barrier layer is not exist at the sites. Alternatively, a mask may be used such that the water vapor barrier layer is not formed at the joint sites. More particularly, the water vapor barrier layer may be totally formed with a mask applied to the region for the joint sites, and then the mask may be removed.

### Examples

Verification tests were performed in accordance with the present invention. The structure of FIG. 7 was employed for the structure of the solid-state battery package.

Specifically, solid-state battery packages according to Examples 1 to 4 shown in Table 1 below were manufactured. Specifically, the covering precursor covered with the covering insulating layer was put into a barrel container, and rotated together with grinding media (alumina powder and alumina balls of 3 mm in diameter) and an organic solvent at a predetermined rotation speed for a predetermined period of time. After the barrel polishing, the covering precursor was subjected to ultrasonic cleaning with the use of an organic cleaning solvent, and dried. Thereafter, a covering inorganic layer was formed by a plating treatment on the covering precursor to obtain a solid-state battery package with an outward curved surface at an end edge bent part. Further, a solid-state battery package subjected to no processing step for forming the outward curved surface was used as a comparative example. Table 1 shows the radii of curvature of the covering insulating layer and covering inorganic layer at the top surface-side corners and top surface-side ridges of the obtained solid-state battery packages.

TABLE 1

| | | Radius of Curvature (μm) | | | |
|---|---|---|---|---|---|
| | | Top Surface- | Top Surface- | Top Surface- | Top Surface- |
| | | Side Corner | Side Corner | Side Ridge | Side Ridge |
| | | (Covering | (Covering | (Covering | (Covering |
| | Processing | Insulating | Inorganic | Insulating | Inorganic |
| | Condition | Layer) | Layer) | Layer) | Layer) |
| Comparative | no barrel | 34.7 | 116.0 | 4.6 | 64.2 |
| Example | processing | | | | |
| Example 1 | rotation at | 49.5 | 144.4 | 34.9 | 84.7 |
| | 150 RPM for | | | | |
| | 1 hour | | | | |
| Example 2 | rotation at | 85.8 | 165.4 | 51.8 | 99.6 |
| | 150 RPM for | | | | |
| | 2 hours | | | | |
| Example 3 | rotation at | 101.8 | 176.7 | 61.2 | 128.4 |
| | 150 RPM for | | | | |
| | 3 hours | | | | |
| Example 4 | rotation at | 123.0 | 203.0 | 79.8 | 145.6 |
| | 100 RPM for | | | | |
| | 10 hours | | | | |

The radii of curvature of the respective covering layers, listed in Table 1, were determined from an image acquired with the use of microscope (model number: VHX-6000 manufactured by KEYENCE CORPORATION) for a section processed with the use of an ion milling apparatus (model number SU-8040 manufactured by Hitachi High-Tech Corporation).

The solid-state batteries according to the comparative examples and the examples were subjected to a test for simulating mechanical stress. The test was performed in such a manner that 100 solid battery packages according to each of the examples and comparative examples were put into a separate barrel container and rotated at 10 RPM for 1 hour to cause the solid-state battery packages to collide with each other. Thereafter, the solid-state battery packages were taken out from the barrel container, and the presence or absence of cracks in the outermost covering inorganic layer was determined by microscopic observation at a magnification of 30 times.

Furthermore, the solid-state battery packages subjected to the mechanical stress test were subjected to a test for evaluating the water vapor ingress prevention of the exterior part. Specifically, the solid-state battery package stored for 500 hours under a high-temperature and high-humidity environment at a temperature of 85° C. and a relative humidity of 85% was then subjected to a charge-discharge test for evaluation. For the charge-discharge test, the solid-state battery packages according to the comparative examples and the respective examples were charged at a constant current of 10 mA at 25° C. until reaching 4.2 V, and after reaching 4.2 V, charged at the constant voltage until reaching 1 mA. Thereafter, the solid-state battery packages were discharged at 25° C. with a constant current of 10 mA and a cutoff voltage of 2V. 30 cycles of charge-discharge in total were performed with the above-mentioned charge-discharge regarded as one cycle. In accordance with the above-described test, a case where the charge-discharge efficiency ((discharge capacity)/(charge capacity)×100 [%]) of the solid-state battery at the time of 30 cycles was 90% or more was evaluated as good, while a case where the charge-discharge efficiency was less than 90% was evaluated as defective. The results of the respective tests are shown in Table 2.

TABLE 2

| | | Battery Performance Evaluation |
|---|---|---|
| | | after Storage at High |
| | Crack after Stress Test | Temperature and High Humidity |
| | (with/without) | (defective/good) |
| Comparative | 31/69 | 31/69 |
| Example | | |
| Example 1 | 0/100 | 0/100 |
| Example 2 | 0/100 | 0/100 |
| Example 3 | 0/100 | 0/100 |
| Example 4 | 0/100 | 0/100 |

According to the results mentioned above, the solid-state battery packages according to Examples 1 to 4 have achieved the results with the exterior parts less cracked after the mechanical stress test, because the solid-state battery packages have the structure including the outward curved surface at the end edge bent part. In contrast, about 30% of the solid-state battery packages according to the comparative example have cracks scattered due to the mechanical stress test, because the solid-state battery packages include no outward curved surface. More particularly, including the outward curved surface at the end edge bent part of the exterior part reduced the crack generation of the exterior part due to mechanical stress from the outside.

Furthermore, according to the results of the charge-discharge test, the solid-state battery packages according to Examples 1 to 4 have not been found to cause degradation in the battery performance of the solid-state batteries also in the high-temperature and high-humidity environment, and thus, it has been demonstrated that the exterior part function of preventing ingress of water vapor suitably works. In contrast, the solid-state battery packages according to the comparative example have the result with the battery performance degraded in the solid-state battery packages cracked, and it has been confirmed that the water vapor ingress prevention of the exterior part was impaired by mechanical stress. Accordingly, the present invention provides more reliable solid-state battery packages that have resistance improved to mechanical stress from the outside.

Although the embodiments of the present invention have been described above, typical examples have been only illustrated. Those skilled in the art will easily understand that the present invention is not limited thereto, and various embodiments are conceivable without changing the scope of the present invention.

It is to be noted that an embodiment of the present disclosure as described above encompasses the following preferable aspects.

First Aspect:

A solid-state battery package including a substrate; a solid-state battery on the substrate; and an exterior part that covers the solid-state battery, where the exterior part includes a plurality of corners, and at least a top surface-side corner of the plurality of corners has an outward curved surface that is curved outward relative to the solid-state battery.

Second Aspect:

The solid-state battery package according to the first aspect, wherein the plurality of corners include a plurality of the top surface-side corners, where a top surface-side ridge connecting adjacent top surface-side corners among the plurality of top surface-side corners is an outward curved surface relative to the solid-state battery.

Third Aspect:

The solid-state battery package according to the second aspect, where the top surface-side ridge is a boundary part between a first surface region and a second surface region that are adjacent to each other and that extend in different directions, and the outward curved surface of the top surface-side ridge extends from the first surface region to the second surface region.

Fourth Aspect:

The solid-state battery package according to any one of the first to third aspects, where the exterior part includes a bottom surface-side corner covering the substrate, and the bottom surface-side corner includes an outward curved surface.

Fifth Aspect:

The solid-state battery package according to any one of the first to fourth aspects, where the exterior part includes a plurality of bottom surface-side corners covering the substrate, and a bottom surface-side ridge connecting a first bottom surface-side corner and a second bottom surface-side corner adjacent to each other among the plurality of bottom surface-side corners includes an outward curved surface relative to the solid-state battery.

Sixth Aspect:

The solid-state battery package according to any one of the first to fifth aspects, where the exterior part includes a bottom surface-side corner covering the substrate, and a side surface-side ridge connecting the top surface-side corner and the bottom surface-side corner includes an outward curved surface relative to the solid-state battery.

Seventh Aspect:

The solid-state battery package according to any one of the first to seventh aspects, where the outward curved surface has a radius of curvature of 35 μm to 250 μm.

Eighth Aspect:

The solid-state battery package according to any one of the first to seventh aspects, where the exterior part includes a covering insulating layer that covers at least a top surface and a side surface of the solid-state battery, and a covering inorganic layer on the covering insulating layer, and at least the covering inorganic layer includes a curved inorganic surface curved outward at the outward curved surface relative to the solid-state battery.

Ninth Aspect:

The solid-state battery package according to the eighth aspect, where in a sectional view, the covering insulating layer located inside the curved inorganic surface includes a curved insulating surface curved outward relative to the solid-state battery.

Tenth Aspect:

The solid-state battery package according to the ninth aspect, where in a sectional view, the curved inorganic surface is larger in radius of curvature than the curved insulating surface.

Eleventh Aspect:

The solid-state battery package according to any one of the eighth to tenth aspects, where the curved inorganic surface at the top surface-side corner has a radius of curvature of 120 μm to 250 μm in a sectional view.

Twelfth Aspect:

The solid-state battery package according to any one of the ninth aspect and the tenth and eleventh aspects based on the ninth aspect, where the curved insulating surface at the top surface-side corner has a radius of curvature of 45 μm to 150 μm in a sectional view.

Thirteenth Aspect:

The solid-state battery package according to any one of the eighth to twelfth aspects, where a top surface-side ridge connecting the top surface-side corners adjacent to each other includes a curved inorganic surface curved outward, and the curved inorganic surface at the top surface-side corner is larger in radius of curvature than the curved inorganic surface at the top surface-side ridge.

Fourteenth Aspect:

The solid-state battery package according to the thirteenth aspect, where the curved inorganic surface of the top surface-side ridge has a radius of curvature of 80 μm to 200 μm.

Fifteenth Aspect:

The solid-state battery package according to the thirteenth or fourteenth aspect, where in a sectional view, the covering insulating layer located inside the curved inorganic surface at the top surface-side ridge includes a curved insulating surface curved outward relative to the solid-state battery, and the curved insulating surface at the top surface-side corner is larger in radius of curvature than the curved insulating surface at the top surface-side ridge.

Sixteenth Aspect:

The solid-state battery package according to any one of the thirteenth to fifteenth aspects, where in a sectional view, the covering insulating layer located inside the curved inorganic surface at the top surface-side ridge includes a curved insulating surface curved outward relative to the solid-state battery, and the curved insulating surface at the top surface-side ridge has a radius of curvature of 35 μm to 120 μm.

Seventeenth Aspect:

The solid-state battery package according to any one of the eighth to sixteenth aspects, where the substrate includes a first main surface facing the solid-state battery and a second main surface on the side opposite to the first main surface, the covering inorganic layer extends to the second principal surface, and the substrate located inside the curved inorganic surface is curved outward in a sectional view relative to the solid-state battery.

Eighteenth Aspect:

The solid-state battery package according to any one of the eighth to seventeenth aspects, where the covering inorganic layer is a composite inorganic film that has two or more laminated inorganic films, and each of the two or more laminated inorganic films is curved outward at the outward curved surface in a sectional view relative to the solid-state battery.

Nineteenth Aspect:

The solid-state battery package according to any one of the fourth aspect and the fifth to eighteenth aspects based on the fourth aspect, where in a sectional view, the outward curved surface at the top surface-side corner is different in radius of curvature than that of the outward curved surface at the bottom surface-side corner.

Twentieth Aspect:

The solid-state battery package according to any one of the fourth aspect and the fifth to nineteenth aspects based on the fourth aspect, where in a sectional view, the outward curved surface at the top surface-side corner has a larger radius of curvature than the outward curved surface at the bottom surface-side corner.

Twenty-First Aspect:

The solid-state battery package according to any one of the first to twentieth aspects, where the solid-state battery package has a rectangular shape in a sectional view, and the plurality of corners of the exterior part covering the solid-state battery each include an outward curved surface relative to the solid-state battery.

The solid-state battery package according to the present invention can be used in various fields where battery use or power storage can be assumed. By way of example only, the solid-state battery package according to the present invention the present invention can be used in the fields of electricity, information, and communication in which mobile devices and the like are used (such as the field of electric/electronic devices and the field of mobile devices including small electronic devices such as mobile phones, smartphones, notebook computers and digital cameras, activity trackers, arm computers, electronic paper, RFID tags, card-type electronic money, and smartwatches), home and small industrial applications (such as the fields of power tools, golf carts, and home, nursing, and industrial robots), large industrial applications (such as the fields of forklifts, elevators, and harbor cranes), the field of transportation systems (such as the fields of hybrid vehicles, electric vehicles, buses, trains, power-assisted bicycles, and electric two-wheeled vehicles), power system applications (such as the fields of various types of power generation, road conditioners, smart grids, and home energy storage systems), medical applications (field of medical equipment such as earphone hearing aids), pharmaceutical applications (fields such as dosage management systems), IoT fields, space and deep sea applications (such as the fields of space probes and submersibles), and the like.

What is claimed is:

1. A solid-state battery package comprising:
a substrate;
a solid-state battery on the substrate; and
an exterior part that covers the solid-state battery,
wherein the exterior part comprises a plurality of corners, and at least a top surface-side corner of the plurality of corners has an outward curved surface that is curved outward relative to the solid-state battery.

2. The solid-state battery package according to claim 1, wherein the plurality of corners comprise a plurality of the top surface-side corners, and
wherein a top surface-side ridge connecting adjacent top surface-side corners among the plurality of top surface-side corners is an outward curved surface relative to the solid-state battery.

3. The solid-state battery package according to claim 2, wherein
the top surface-side ridge is a boundary part between a first surface region and a second surface region that are adjacent to each other and that extend in different directions, and
the outward curved surface of the top surface-side ridge extends from the first surface region to the second surface region.

4. The solid-state battery package according to claim 1, wherein
the exterior part comprises a bottom surface-side corner covering the substrate, and
the bottom surface-side corner comprises an outward curved surface relative to the solid-state battery.

5. The solid-state battery package according to claim 1, wherein
the exterior part comprises a plurality of bottom surface-side corners covering the substrate, and
a bottom surface-side ridge connecting a first bottom surface-side corner and a second bottom surface-side corner adjacent to each other among the plurality of bottom surface-side corners comprises an outward curved surface relative to the solid-state battery.

6. The solid-state battery package according to claim 1, wherein
the exterior part comprises a bottom surface-side corner covering the substrate, and
a side surface-side ridge connecting the top surface-side corner and the bottom surface-side corner comprises an outward curved surface relative to the solid-state battery.

7. The solid-state battery package according to claim 1, wherein the outward curved surface has a radius of curvature of 35 μm to 250 μm.

8. The solid-state battery package according to claim 1, wherein
the exterior part comprises a covering insulating layer that covers at least a top surface and a side surface of the solid-state battery, and a covering inorganic layer on the covering insulating layer, and
at least the covering inorganic layer comprises a curved inorganic surface curved outward at the outward curved surface relative to the solid-state battery.

9. The solid-state battery package according to claim 8, wherein in a sectional view, the covering insulating layer located inside the curved inorganic surface comprises a curved insulating surface curved outward relative to the solid-state battery.

10. The solid-state battery package according to claim 9, wherein in a sectional view, the curved inorganic surface is larger in radius of curvature than the curved insulating surface.

11. The solid-state battery package according to claim 8, wherein the curved inorganic surface at the top surface-side corner has a radius of curvature of 120 μm to 250 μm in a sectional view.

12. The solid-state battery package according to claim 9, wherein the curved insulating surface at the top surface-side corner has a radius of curvature of 45 μm to 150 μm in a sectional view.

13. The solid-state battery package according to claim 2, wherein
the exterior part comprises a covering insulating layer that covers at least a top surface and a side surface of the solid-state battery, and a covering inorganic layer on the covering insulating layer,
at least the covering inorganic layer comprises a curved inorganic surface curved outward at the outward curved surface relative to the solid-state battery,
a top surface-side ridge connecting the top surface-side corners adjacent to each other comprises the curved inorganic surface curved outward, and
the curved inorganic surface at the top surface-side corner is larger in radius of curvature than the curved inorganic surface at the top surface-side ridge.

14. The solid-state battery package according to according to claim 13, wherein the curved inorganic surface of the top surface-side ridge has a radius of curvature of 80 μm to 200 μm.

15. The solid-state battery package according to according to claim 13, wherein
in a sectional view, the covering insulating layer located inside the curved inorganic surface at the top surface-side ridge comprises a curved insulating surface curved outward relative to the solid-state battery, and
the curved insulating surface at the top surface-side corner is larger in radius of curvature than the curved insulating surface at the top surface-side ridge.

16. The solid-state battery package according to claim 13, wherein
in a sectional view, the covering insulating layer located inside the curved inorganic surface at the top surface-side ridge comprises a curved insulating surface curved outward relative to the solid-state battery, and
the curved insulating surface at the top surface-side ridge has a radius of curvature of 35 μm to 120 μm.

17. The solid-state battery package according to claim 8, wherein
the substrate comprises a first main surface facing the solid-state battery and a second main surface on a side opposite to the first main surface,
the covering inorganic layer extends to the second principal surface, and
the substrate located inside the curved inorganic surface is curved outward in a sectional view relative to the solid-state battery.

18. The solid-state battery package according to claim 8, wherein
the covering inorganic layer is a composite inorganic film that has two or more laminated inorganic films, and
each of the two or more laminated inorganic films are curved outward at the outward curved surface in a sectional view relative to the solid-state battery.

19. The solid-state battery package according to claim 4, wherein in a sectional view, the outward curved surface at the top surface-side corner is different in radius of curvature than that of the outward curved surface at the bottom surface-side corner.

20. The solid-state battery package according to claim 4, wherein in a sectional view, the outward curved surface at the top surface-side corner has a larger radius of curvature than the outward curved surface at the bottom surface-side corner.

21. The solid-state battery package according to claim 1, wherein the solid-state battery package has a rectangular shape in a sectional view, and the plurality of corners of the exterior part covering the solid-state battery each comprise an outward curved surface relative to the solid-state battery.
